(19) United States
(12) Patent Application Publication
(10) Pub. No.: US 2011/0088090 A1
(43) Pub. Date: Apr. 14, 2011

(54) ENHANCEMENTS TO CLAIMS BASED DIGITAL IDENTITIES

(75) Inventors: Gerard D. O'Brien, Surrey (GB); James A.L. Porter, Swanage (GB); Susan E. Morrow, Stocksfield (GB); Stephen M. Hitchen, Stocksfield (GB); Paul Battersby, Cramlington (GB); Alexandar James John Porter, Swanage (GB)

(73) Assignee: Avoco Secure Ltd., London (GB)

(21) Appl. No.: 12/877,648

(22) Filed: Sep. 8, 2010

Related U.S. Application Data
(60) Provisional application No. 61/240,519, filed on Sep. 8, 2009.
(60) Provisional application No. 61/253,136, filed on Oct. 20, 2009.
(60) Provisional application No. 61/307,521, filed on Feb. 24, 2010.

(51) Int. Cl. H04L 9/32; G06F 21/00

(52) U.S. Cl. 726/19

(57) ABSTRACT

A system and method of identifying a user to a digital system is disclosed. The method includes receiving a request for a value of an identification claim of a digital identity from a relying party, allowing a user to select the digital identity via an identification selector, querying an identification provider for the value of the identification claim, and providing the value of the identification claim to the relying party.

### CROSS-REFERENCE TO RELATED APPLICATIONS

This patent application claims the benefit of U.S. Provisional Application Ser. No. 61/240,519, filed in the U.S. Patent and Trademark Office (USPTO) on Sep. 8, 2009, U.S. Provisional Application Ser. No. 61/253,136 filed in the USPTO on Oct. 20, 2009, and U.S. Provisional Application Ser. No. 61/307,521 filed in the USPTO on Feb. 24, 2010, the entire contents of each of these applications being hereby incorporated by reference herein.

### TECHNICAL FIELD

The present invention generally relates to the field of digital identification, and more particularly, to systems and methods for identifying a user to a digital system to give the user access to documents, services, and systems.

### BACKGROUND

A number of schemes have been devised to provide users of computer systems with a means of digital identification, in effect, digital equivalents of identification papers. These may be used to identify a user to a digital system, such as a web site or other resource.

Known systems allow a user to provide information regarding their identity, but such systems typically only provide limited ability to utilize such information as the basis for digital identification.

### SUMMARY

The invention relates to systems and methods for identifying a user to a digital system. Systems and methods according to the invention are more versatile relative to existing systems and methods for identifying a user to a digital system. This is accomplished, for example, by systems and methods according to the invention utilizing identification claims as the basis for digital identification.

In one aspect, the invention relates to a system for identifying a user to a digital system. The system includes a processor and storage embedded with instructions. The instructions are executable by the processor to cause the processor to receive a request for a value of an identification claim of a digital identity from a relying party, allow the user to select the digital identity via an identification selector, query an identification provider for the value of the identification claim, and provide the value of the identification claim to the relying party.

In one embodiment according to this aspect of the invention, the value of the identification claim is digitally signed by the identification provider.

In another embodiment according to this aspect of the invention, the identification claim is a digital rights control. The digital rights control can be set dynamically by the identification provider.

In another embodiment according to this aspect of the invention, the processor can further create a digital certificate using the value of the identification claim.

In another embodiment according to this aspect of the invention, the identification claim can include any one or more of an encryption key, a rating of the user's financial status, the user's progress through various steps of an application process, the integrity of a website, the user's health records, the user's professional licenses, the user's professional qualification, the user's geographic position, the user's credit rating, the user's online gaming information, a monetary conversion rate, a share value, a company profile, and expiration data.

In another embodiment according to this aspect of the invention, the value of the identification claim can be obtained in a real-time from a third party. The value of the identification claim can also be calculated using fuzzy set theory. The value of the identification claim can be determined by the combination of other identification claims.

In another embodiment according to this aspect of the invention, the processor can further notify the user of a change in the value of the identification claim. The system can further comprise an anti-phishing mechanism. The digital identity can also be automatically imported into the identification selector. The relying party can also specify a permitted authentication method.

In another embodiment according to this aspect of the invention, the relying party can specify acceptable digital identity providers. The user can also control which identification claims are returned to the relying party. The source of the value of the identification claim can also be displayed to the user. The relying party can also specify the source of the value of the identification claim.

In another embodiment according to this aspect of the invention, the value of the identification claim can further include an indication of the trust level of the identification claim. The identification selector can also be a cloud identification selection.

In a second aspect, the invention relates to a method of identifying a user to a digital system over a computer network. The method is executed by a computer server in the computer network. The method includes receiving a request for a value of an identification claim of a digital identity from a relying party, allowing the user to select the digital identity via an identification selector, transmitting the selected digital identity to the relying party, querying an identification provider for the value of the identification claim, and providing the value of the identification claim to the relying party.

These and other objects, along with advantages and features of the invention herein disclosed, will become apparent through reference to the following description, the accompanying drawings, and the claims. Furthermore, it is to be understood that the features of the various embodiments described herein are not mutually exclusive and can exist in various combinations and permutations.

### BRIEF DESCRIPTION THE DRAWINGS

The objects and features of the present disclosure, which are believed to be novel, are set forth with particularity in the appended claims. The present disclosure, both as to its organization and manner of operation, together with further objectives and advantages, may be best understood by reference to the following description, taken in connection with the accompanying drawings as set forth below:

FIG. 1 is a flow diagram of a system for identifying a user to a digital system.

FIG. 2 is a flow diagram of a method of identifying a user to a digital system over a computer network.

### DETAILED DESCRIPTION

The invention relates to systems and methods for identifying a user to a digital system. Systems and methods according to the invention are more versatile relative to existing systems and methods for identifying a user to a digital system. This is accomplished, for example, by systems and methods according to the invention utilizing identification claims as the basis for digital identification.

A number of schemes have been devised to provide users of a computer system with a means of digital identification, in effect, digital equivalents of identification papers. These may be used to identify a user to a digital system, such as a web site or other resource.

One type of system uses identification claims or identification attributes as the basis for identification. These identification claims are attributes that an owner of a digital identity claims to possess, such as their name, email address, and telephone number. The values of these identification claims are supplied by an identification provider when the identification claims are requested by a relying party, such as a website.

Users can manage their digital identities from different identification providers with an identification selector and associated identity system components. The identification selector enables users to use their digital identities to access online services. In this manner, identities are presented to users as “Information Cards”. Information Cards can be used both at applications hosted on websites accessed through commercially available internet browsers and rich client applications directly employing internet services.

The identification claims within, or associated with a digital identity need not be restricted to direct attributes of the owner's identity. For example, these can be any type of information that can help or enhance the use of the identity in providing information to an external system that can use the identification claims.

For example, a digital identity used to control access to a library system may store, as an identification claim, the books that the identity's owner currently has on loan. The list of books, stored as an identification claim, is not an attribute of the identity's owner, but rather is something associated with this person, and is an identification claim in the sense that these are the books that are being claimed that the owner has on loan.

An important distinction here is that, although the digital identity is associated with a specific individual, and identification claims related directly to an owner's attributes would usually be supplied by that individual (e.g. their name), the identification claim of books on loan is not set by the owner, but rather they are set by the library, as the owner borrows and returns books.

The invention describes enhancements to the use of claims-based digital identities, exemplified by Information Cards but equally applicable to any identity system that utilizes identification claims or identification attributes that carry information related to the identity owner. An example of another claims-based identity system is OpenID, where identification claims are described as attributes.

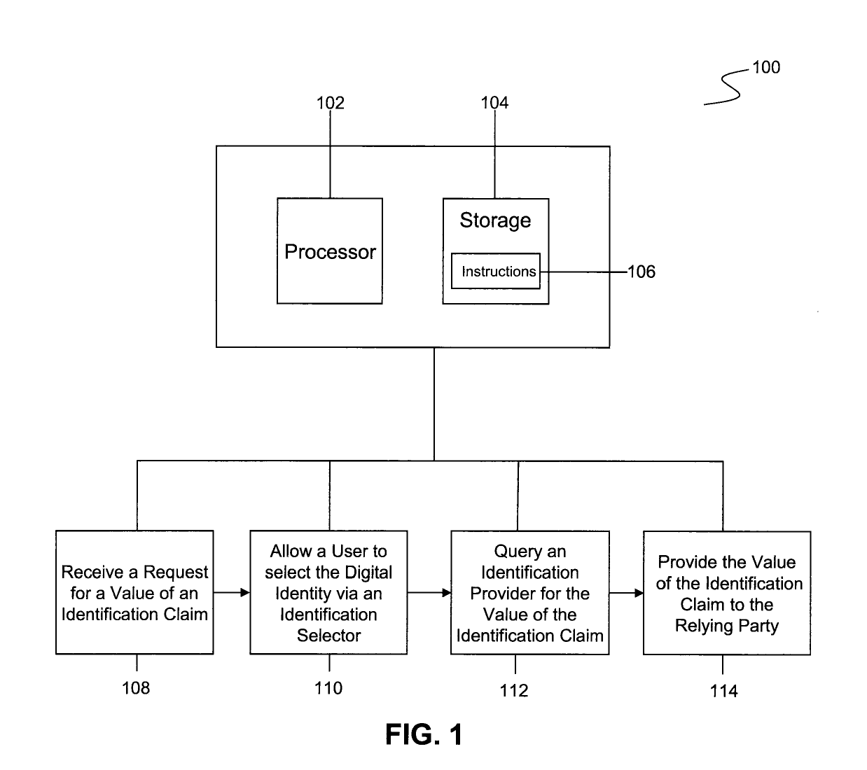

Referring now to FIG. 1, in one embodiment according to the invention, a system 100 for identifying a user to a digital system includes a processor 102 and storage 104 embedded with instructions 106. The processor 102 can be implemented as, for example, embedded microprocessors as part of a computer system. The instructions 106 include computer code designed for executing a specific purpose or purposes. The storage 104 can be, for example, any one or more of magnetic storage media such as hard disks, floppy disks, and magnetic tape, optical storage media such as compact disks or digital video discs, read-only memory (“ROM”), random-access memory (“RAM”), and flash memory devices.

The instructions 106 embedded within the storage 104 are executable by the processor 102. When executed, these instructions 106 cause the processor 102 to perform any number of functions. For example, the instructions 106 cause the processor 102 to: receive a request for a value of an identification claim of a digital identity from a relying party 108, allow the user to select the digital identity via an identification selector 110, query an identification provider for the value of the identification claim 112, and provide the value of the identification claim to the relying party 114.

In operation, the system 100 initially receives the request for a value of an identification claim of a digital identity from a relying party 108. The system 100 subsequently allows the user to select the digital identity via an identification selector 110. The system 100 queries an identification provider for the value of the identification claim 112. The system 100 provides the value of the identification claim to the relying party 114 in response to the query of the identification provider.

In one embodiment according to this aspect of the invention, the value of the identification claim is digitally signed by the identification provider. This mechanism is provided because the relying party may need to know the origin and validity of the value of the identification claim being presented. For example, if an identification claim indicates the owner of the identification claim is over twenty-one years of age, the relying party has no means of verifying this identification claim or checking the identification claim against forgery. In such instances, the relying party can either trust the identification provider or require the identification provider to verify the identification claim being issued. Because the value of identification claims may originate externally to the identification provider, the relying party can require the identification party to digitally sign the value of the identification claim. A digitally signed identification claim can be traced and forgery would be extremely difficult, if not impossible. The identification claims can also be countersigned by appropriate parties and time stamped to show when they were issued or verified.

In another embodiment according to this aspect of the invention, the identification claim is a digital rights control. For example, the system 100 can permit access to the content of files and emails on the basis of the identification claims presented by the user attempting to access such files or emails. The emails or files can be encrypted using a symmetric key and decryption is only permitted if the user presents the correct rights. The encryption key can be stored within the document and is encrypted with white box encryption and, optionally, a key derived from the identification claims.

The digital rights control can also be set dynamically by the identification provider when the identification claims are requested. This mechanism can allow for increasing or decreasing the digital rights control in real time when a file or email is accessed by the user. This conveniently combines access control and rights restrictions into a single system, controlled by the identification claims issued by the identification provider. A name or other data can also be used to identify the file or email and this may also be passed to the identification provider to provide an extra level of information for use when determining the access rights and/or digital rights control.

In another embodiment according to this aspect of the invention, the processor 102 can further create a digital certificate using the value of the identification claim. For example, a user can digitally sign information by creating a standard X509 or similar digital certificate using the value of the identification claim as the basis for creating key pairs required for signing the digital certificate. The key pairs and digital certificate may be transient and not stored but destroyed immediately after use. Accordingly, a user who does not have available a conventional digital certificate to digitally sign web forms and other electronic documents may use a digital certificate generated from verified identification claims, thus creating a digital certificate with a high assurance that it belongs to the user and that the signatures created using it were signed by the user.

In another embodiment according to this aspect of the invention, the identification claim can include any one or more of an encryption key, a rating of the user's financial status, the user's progress through various steps of an application process, the integrity of a website, the user's health records, the user's professional licenses, the user's professional qualification, the user's geographic position, the user's credit rating, the user's online gaming information, a monetary conversion rate, a share value, a company profile, an expiration data, and an out-of-band authentication mechanism.

For example, the identification claim can include an encryption key for access to encrypted resources. Because the identification claims can be issued dynamically, the encryption key can be provided in the form of a single-use or one-time password, which would permit a single-use access to the digital identity.

In another example, the identification claim can used to give a rating of a user's financial status. The rating claim can be presented in the form of a star rating. The value of the rating can be obtained by the identification provider as the identification claims are requested by the relying party. These requests can be made from the relying party to a database, an external web service or other data source, such that the value of the identification claim is up-to-date or a real time value.

The rating can also be used to show the progress of the user through various steps of an application process. For example, the progress can be used to indicate the user's progress through various steps in applying for a mortgage or health insurance, with the progress rating being incremented each time a pre-requisite stage has been completed. External sources can contribute to setting these steps, either directly through a web service or similar, or they can be polled for the information by the identification provider.

The rating can also be indicative of the integrity or security of the relying party's website. This rating can be indicated to the user in a variety of manners. For example, a red-amber-green light display, in the form of a signaling card, can be used to represent the rating of the relying party's website.

The use of ratings can also be linked to a fraud detection system associated with payments. The identification selector can obtain the ratings information and displays the result to the user. In this case, the rating would not require an identification claim.

In another example, the identification claim can be a user's health records. The use of a user's health records as an identification claim would be beneficial in a variety of circumstances. For example, this identification claim can be useful when presenting a digital identity to login to an on-line pharmacy or for on-line booking of medical, dental or veterinary appointments where pre-existing conditions data, such as x-rays and other scans, existing medications and allergies, can be available to the relevant parties. These identification claims can present real-time data, if obtained from an appropriate source.

In another example, the identification claim can be a user's professional license(s). For example, the identification claim can be used by independent sources to verify that a user, such as a health care worker, is trained in a particular specialty, insured, or has not been disbarred and is currently licensed to practice as well as has a patient's authorization to access their medical records. A real time value of the membership or professional status of a user can be obtained from a source such as real-time access to the professional body's database or web service, such that the information supplied as the identification claim to the relying party is always up to date.

In another example, the identification claim can be a user's professional qualifications. For example, the identification claim can be used by an independent source to verify that the user is a member of a professional organization or body. Examples can include membership in law societies, engineers, pharmacists, or any other profession where current membership of the associated professional body would be a requirement to access certain sites or services. A real time value of the membership or professional status can be obtained from a source, such as real-time access to the professional body's database or web service, such that the information supplied as the identification claim to the relying party is always up-to-date. The user's professional qualification can also be useful to a recruitment agency, as well as potential employers. Employers may have issues with fraudulent applications for jobs where applicants state they have a particular qualification or present qualifications at interview, only to be discovered later as being false. Educational institutions can provide the values for such identification claims and these values can be digitally signed and time-stamped to provide verification of their status.

In another example, the identification claim can be a user's geographic position. For example, the value of the identification claim, (e.g., the user's geographic position), can be provided by the identification provider to the relying party. The geographic position can be obtained from a device, such as a Global Positioning System (GPS) receiver, which is attached to the user's computing device or mobile device, and transmitted to the identification provider. The user's geographic position can also be used by the identification selector to determine if certain identities are available for use. For example, some identities can be restricted so that they may only be used in certain geographic locations, such as a specific country, region, town, or building.

In another example, the identification claim can be a user's credit rating. For example, real time values of a user's credit rating as an identification claim can be supplied to relying parties. The credit rating can be a specific numeric value, such as outstanding loan values, or a more abstracted indication of the user's credit rating or risk status, such as a credit score that is made up from several credit sources. In another example, the identification claim can also be non-personal information, such as a monetary conversion rate, a share value, or a company profile.

In another example, the identification claim can include expiration data. For example, the identification claim can be a specific date and time at which point the integrity of the value of the identification claim is no longer valid. This feature would be particularly relevant in circumstances in which the value of the identification claims are obtained from third parties.

In another example, the identification claim can include a usage counter. For example, an identification claim can be set to calculate the number of times it was requested by a relying party, as a means, for example, of determining how often a particular document or web page was accessed. The usage count can also be used to limit the use of the identification claim to a maximum number of times, so limiting access to the resource that requires the identification claim.

In another example, the identification claim can be real-time values that are obtained from third party sources. An example of this can be an online booking system, where a required identification claim can be the user's credit rating obtained in real time from a credit agency when the identification claim is requested.

In another example, an out-of-band authentication mechanism can be used to authenticate the user to the identification selector or identification provider. An out-of-band authentication mechanism can be, for example, voice biometrics or SMS text messaging to supply alternative sign-in credentials to an identification selector. For example, the user can record their mobile telephone with the system during registration. To subsequently access their account, they can enter an identifier in the system sign in system (such as their email address.) This can then be used to lookup their associated telephone number and a one-time password or similar code would be sent to this number by SMS. On receiving the code on their mobile telephone, the user can enter the code into the sign-in system and be verified and signed in. An extension of this mechanism can be the application of out-of-band authentication to authenticate use of a digital identity, such as an information digital identity card or OpenID, to provide an alternative and strong method of authentication when using the identity.

In another example, the identification claim can be a user's online gaming information, such as their online persona, online game status, game points or credits or similar online gaming information that would need to be presented when signing in to an on-line game. This information can also be used to supply credits or funds for online gambling.

In another embodiment according to this aspect of the invention, the value of the identification claim can be calculated using fuzzy set theory in cases where the information cannot be exactly defined. For example, the value of the identification claim does not have precisely defined values for the following types of identification claims: (i) is the user an old person; (ii) is the user a tall person; and (iii) does the user have a good credit rating. In these circumstances, an uncertain value of a particular variable (e.g. height) is expressed as a characteristic function of the variable. This function is called the membership function, m(x), where x is the variable (e.g. height) and it is normalized to a range between zero and one, with zero representing no membership and one maximal membership. In this manner, fuzzy set theory is used to describe uncertain identification claim values and store these values as membership values of the appropriate fuzzy set. In this way, identification claims referring to such indefinite values can be utilized precisely.

In another embodiment according to this aspect of the invention, the value of the identification claim can be determined by the combination of other identification claims. For example, the combined (aggregated) value of identification claims will reflect, dynamically, the effect of changes to the values of the identification claims that contribute to it. This can be used, for example, to derive a dynamic trust level identification claim, that shows a user's trust level, based on the values of several other identification claims such as those based on the user's current credit status and feedback rating. Another example can be a user rating based upon simply having specific identification claims, such as a low rating can be given where the user has few or none of the required identification claims, with the rating increasing as more identification claims are obtained. Fuzzy set theory can be used to combine the input values where distinct or indefinite quantities are involved.

In another embodiment according to this aspect of the invention, the processor 102 can further notify the user of a change in the value of the identification claim. For example, an identification claim can be the credit rating of the user, and the user can subsequently be notified if their credit rating has changed since the last time they presented their digital identity. This change can be provided by the identification selector; however, the change can also come either from the supplier of the identification claims data or the identification provider, if any of these components maintains a record of previous values.

In another embodiment according to this aspect of the invention, the system 100 can further comprise an anti-phishing mechanism. In this configuration, the identification selector runs on a remote server and can be accessed through the Internet. In order to prevent the operator of a phishing website, which provides a fake login page and gathers various usernames and passwords for illegal purposes, the identification selector can include a shared secret, known only to the user and the identification selector. For example, a user can enter their user name in the login page displayed by the identification selector. The identification selector looks up the user in a database or store and retrieves the shared secret. This secret is displayed to the user, either (a) by itself or (b) with other possible candidates. In the case of (a) a prompt to the user urges them to enter their password only if the displayed secret is correct. If method (b) is used, the user must pick the correct secret from those displayed before they are prompted for their password.

The anti-phishing mechanism can prevent phishing because the operator of the phishing site cannot know the shared secret, therefore only the bone fide identification selector login page can show the correct secret. A potential attack on this mechanism can be to enter repeatedly enter guessed user names until a secret is displayed. To avoid this, the identification selector can display something that can be a potential secret when a username is entered that is not in the database or store of users. The shared secret can also be set by the user when registering their details with the identification selector. The secret can be a word, phrase, an image, or a sound. The user can be permitted to choose a secret from one provided by the identification selector, or to use one of their own, such as an image or photo. An important aspect of this secret is that it can be a claim associated with one or more of the user's identities stored in the identification selector. This can either be a general identification claim, or one specifically designated for this purpose, an authentication identification claim.

In another embodiment according to this aspect of the invention, the digital identity can be automatically imported into the identification selector. This process may be initiated by the user either when a new, managed digital identity is applied for, or later. An alternative method can be for the user to instruct the identification selector to contact the issuer for a list of digital identities that can be imported. Through a tighter integration of the identification selector with the issuer of the digital identities, this process of importing of digital identities can be completely automated, eliminating any user interaction.

In another embodiment according to this aspect of the invention, the relying party can specify permitted authentication methods that are to be permitted when authenticating the use of a digital identity. The permitted authentication method is specified as parameters to the identification selector, as an addition to the parameters that specify the required identification claims, token type, etc. In the event that an identification selector is not available or used, an alternative mechanism can be invoked. In this case the relying party includes a special custom identification claim in the list of identification claims that it requires. This identification claim indicates the authentication required, for example, if it is required that the user must use a digital identity authenticated with an X509 certificate. As an example, this can be called an X509_card_authentication claim.

In this instance, the identification selector only allows the user to pick a digital identity that can supply the required identification claims, so that the digital identity that has the X509_card_authentication claim can be selected. To enforce the use of the X509 authentication, only digital identities that use this authentication would be issued with this identification claim. The combination of these features fulfils the requirements of the relying party that only a digital identity that is authenticated with an X509 digital certificate can be used to supply the identification claims required. This methodology can clearly be applied to specifying other types of authentication (e.g. that a personal card or username/password or Kerberos token or OpenID, etc., must be used) and it can also be used to specify that multiple authentication methods, either any one of those specified, all of those specified or any not specified.

Further enhancements can be made when the identification claim values are returned by the identification provider; for example, details of the X509 certificate used for authentication can be returned. Additionally, using these methods, the relying party can specify other requirements such as that the digital identity certificate be issued by a specific certificate authority, or that it contain specific policies, or be an OCSP validated certificate.

In another embodiment according to this aspect of the invention, the relying party can specify acceptable digital identity providers. By enabling the relying party to specify acceptable digital identity providers, a much finer degree of control is afforded. For example, if a relying party trusts identification claims associated with two specific digital identity issuers, this feature allows both to be specified, such that the users with digital identities issued by either digital identity issuers will satisfy this criterion. In this manner, the relying party would not be forced either to specify only a single issuer (therefore possibly reducing the number of potential users that can access the site or service) or allow any issuer, which may lead to the user supplying claims from a source that is untrusted by the relying party.

In another embodiment according to this aspect of the invention, the user can control which identification claims are returned to the relying party. In this manner, the user can pick, from a list of identification claims, each individual identification claim that is to be returned to the relying party. This choice can be made either before the request for a security token message is sent to the identification provider (in which case the identification claim values are not set) or afterwards (in which case the identification claim values will have been retrieved and can be shown to the user.) By permitting the user to choose exactly which identification claims are to be returned, the user is provided with a much greater degree of control over his or her personal information. An extension of this control is to restrict identification claims through a policy. This policy can state that certain identification claims may not be returned to a relying party. The policy can be based on, or modulated by, factors such as the user, the user's geographic location, the user's security clearance, and the relying party. An example can be an organization that wants to restrict users from sending certain identification claims to unauthorized external relying parties. This policy can be applied automatically either in the identification selector or identification provider, but can also be applied through the use of some intermediary system, such as a policy manager.

In another embodiment according to this aspect of the invention, the source of the value of the identification claim can be displayed to the user. For example, the user can determine whether to allow an identification claim to be used, or if there are multiple sources, can also select the source to be used. This functionality gives the end-user much more control over their personal information.

In another embodiment according to this aspect of the invention, the relying party can specify the source of the value of the identification claim. The identity of the source can be in the form of a URL or similar universal address, a digital certificate, a name or other designator that will identify the source of the identification claim value. This information can be in an anonymous, disguised, or encrypted form such that the actual source of the identification claim value may only be determined by authorized or trusted parties. For example, the source can be encrypted using the public key of the identification provider, so that it would not be available in decrypted form to intermediate components of the system 100.

In another embodiment according to this aspect of the invention, the value of the identification claim can further include an indication of the trust level of the identification claim. This trust level can be obtained by interrogation of external services and systems that have audited the validity of the value of the identification claim from a given source. This trust level can vary over time, for example, the more a system supplies a valid value of an identification claim, the more it can be trusted and therefore it gets a higher trust level. Identification claims from certain organizations, such as banks, can also have a higher trust level set, compared to identification claims from individuals or smaller, uncertified organizations. Organizations that supply identification claims can also be certified for supplying identification claims with specific levels of trust, or supply values of identification claims with a certified or guaranteed level of trust. For example an organization can supply certified values of identification claims with different levels of trust and with a price differential between the levels.

In another embodiment according to this aspect of the invention, the identification selector can be a cloud identification selection. A cloud identification selection can be specified and activated in a variety of manners. For example, a user, by clicking a button, image, link or similar input on a web page, can initiate (1) the communication of the settings required by the cloud identification selection to allow selection of an appropriate identity, such as the required claims and claims issuer; and/or (2) activation or display of the cloud identification selection to allow the user to choose a digital identity.

In its simplest form, a cloud identification selection can be set up and invoked by including CSS, HTML, XHTML or XML statements in a web page. The HTML statement can be as simple as a redirection, initiated a link or button, to the required cloud identification selection, with the required parameters such as required identification claims or issuer, as query strings.

The following example shows such a link:

<a
href=“https://www.secure2cardspace.com/CloudCardA/CardView.php?&amp;Issuer=http
%3A%2F%2Fschemas.xmlsoap.org%2Fws%2F2005%2F05%2Fidentity%2Fissuer%2Fs
elf&amp;RequiredClaims=http%3A%2F%2Fschemas.xmlsoap.org%2Fws%2F2005%2F
05%2Fidentity%2Fclaims%2Fsurname+http%3A%2F%2Fschemas.xmlsoap.org%2Fws
%2F2005%2F05%2Fidentity%2Fclaims%2Fgivenname+http%3A%2F%2Fschemas.xml
soap.org%2Fws%2F2005%2F05%2Fidentity%2Fclaims%2Femailaddress+http%3A%2F
%2Fschemas.xmlsoap.org%2Fws%2F2005%2F05%2Fidentity%2Fclaims%2Fprivateper
sonalidentifier&amp;TokURI=https%3A%2F%2Fwww.secure2cardspace.com%2Flogin.
php”>

This can be generalized as

endpoint_uri?Issuer=issuer_uri&ampRequiredClaims=claim_list&ampTokURI=

tok_uri

where

endpoint_uri is the URI, including https prefix, for the endpoint reference of the cloud identification selection.

Example: https://www.secure2cardspace.com/CloudCardA/cardview.php

issuer uri is the endpoint reference for the identification provider that must supply the identification claims. When this is set, the identification selector will only allow digital identity cards to be chosen that are issued by this identification provider. To allow selection of any digital identity cards set this to a blank, (i.e.)

Issuer=″ or Issuer=

To specify that only personal cards can be selected the following can be used:

Issuer=http%3A%2F%2Fschemas.xmlsoap.org%2Fws%2F2005%2F05%2Fidenti

ty%2Fissuer%2Fself

In addition, multiple issuers can be specified, which would allow the user to choose digital identity cards issued by any of the listed issuers.

claim_list is the list of claim URIs, with each URI separated with a space.

Example: for two identification claims: surname and email address, the space separating the two claims has been encoded as ‘+’

RequiredClaims=http%3A%2F%2Fschemas.xmlsoap.org%2Fws%2F2005%2
F05%2Fidentity%2Fclaims%2Fsurname+http%3A%2F%2Fschemas.xmlsoap
.org%2Fws%2F2005%2F05%2Fidentity%2Fclaims%2Femailaddress

In addition to specifying required identification claims, optional identification claims may also be specified, in a similar manner. Furthermore, information that specifies in some way to the identity provider the preferred source of any identification claims values can also be stated, for either required or optional identification claims.

Tok_uri is the URI that the encrypted token is to be returned to. The token will be returned in the form of an HTTP POST.

Example:

https%3A%2F%2Fwww.secure2cardspace.com%2Ftokenprocessor.php

As well as these basic settings, the relying party can optionally specify the type of digital identity that can be selected to fit its requirements (e.g. information card or OpenID). It may also, optionally, specify acceptable types of authentication required to use the digital identity. Additionally, the cloud identification selection can support other settings. Any meaningful name can be used for these parameters, provided that the identification selector eventually receives the data it requires to allow selection of an appropriate digital identity. HTML statements can be placed directly in the page or, more conveniently in some cases, generated, for example using server side or client side code. In a different implementation, a cloud identification selection can be invoked from statements in a client or server side script for example using JavaScript, ASP, Java, or PHP. In a different implementation, the cloud identification selection can be accessed indirectly through a discovery service which can be used to discover available cloud identification selection and or the end point addresses of the identification selectors. In a different implementation, a cloud identification selection can be accessed directly from server side code by sending the required settings from code running on a server. In a different implementation, it can be advantageous to involve a separate system, which can be contacted by the relying party, and the required settings passed to this service, or the service can obtain some or all of them from another system, database or directory, to then send, directly or indirectly to a cloud identification selection. In a different implementation, a server side scripting object can be invoked to interact with a cloud identification selection.

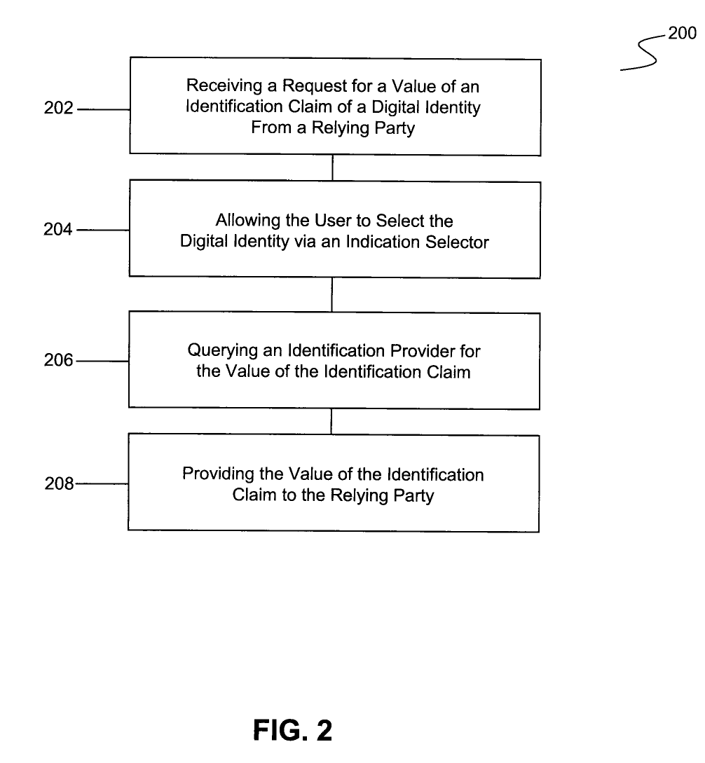

Referring now to FIG. 2, in one embodiment according to the invention, a method 200 of identifying a user to a digital system over a computer network, such as over the Internet, includes the following steps: receiving a request for a value of an identification claim of a digital identity from a relying party 202, allowing the user to select the digital identity via an identification selector 204, querying an identification provider for the value of the identification claim 206, and providing the value of the identification claim to the relying party 208. The method 200 is executed by a computer server in the computer network and the method is not limited to any particular order.

It will be understood that various modifications may be made to the embodiments disclosed herein. Therefore, the above description should not be construed as limiting, but merely as exemplifications of the various embodiments of the present disclosure. Those skilled in the art will envision other modifications within the scope and spirit of the claims appended hereto.

What is claimed is:

1. A system for identifying a user to a digital system, comprising:
a processor; and
a storage embedded with instructions, the instructions being executable by the processor for causing the processor to:
receive a request for a value of an identification claim of a digital identity from a relying party,
allow the user to select the digital identity via an identification selector,
query an identification provider for the value of the identification claim, and
provide the value of the identification claim to the relying party.

2. The system of claim 1 wherein the value of the identification claim is digitally signed by the identification provider.

3. The system of claim 1 wherein the identification claim is a digital rights control.

4. The system of claim 3 wherein the digital rights control is set dynamically by the identification provider.

5. The system of claim 1 wherein the processor further creates a digital certificate using the value of the identification claim.

6. The system of claim 1 wherein the identification claim includes any one or more of an encryption key, a rating of the user's financial status, the user's progress through various steps of an application process, the integrity of a website, the user's health records, the user's professional licenses, the user's professional qualification, the user's geographic position, the user's credit rating, the user's online gaming information, a monetary conversion rate, a share value, a company profile, and expiration data

7. The system of claim 1 wherein the value of the identification claim is obtained in a real-time from a third party.

8. The system of claim 1 wherein the value of the identification claim is calculated using fuzzy set theory.

9. The system of claim 1 wherein the value of the identification claim is determined by the combination of other identification claims.

10. The system of claim 1 wherein the processor further notifies the user of a change in the value of the identification claim.

11. The system of claim 1 further comprising an anti-phishing mechanism.

12. The system of claim 1 wherein the digital identity is automatically imported into the identification selector.

13. The system of claim 1 wherein the relying party specifies a permitted authentication method.

14. The system of claim 1 wherein relying party specifies acceptable digital identity providers.

15. The system of claim 1 wherein the user controls which identification claims are returned to the relying party.

16. The system of claim 1 wherein the source of the value of the identification claim is displayed to the user.

17. The system of claim 1 wherein the relying party specifies the source of the value of the identification claim.

18. The system of claim 1 wherein the value of the identification claim further includes an indication of the trust level of the identification claim.

19. The system of claim 1 wherein the identification selector is a cloud identification selection.

20. A method of identifying a user to a digital system over a computer network, the method executed by a computer server in the computer network, comprising:
receiving a request for a value of an identification claim of a digital identity from a relying party;
allowing the user to select the digital identity via an identification selector;
querying an identification provider for the value of the identification claim; and
providing the value of the identification claim to the relying party.
